(19) United States
(12) Patent Application Publication
(10) Pub. No.: US 2018/0099238 A1
(43) Pub. Date: Apr. 12, 2018

(54) FILTER PAD

(71) Applicant: PURE GRAVITY FILTRATION SYSTEMS, LLC, Conroe, TX (US)

(72) Inventors: BRENDAN S. SIEGERT, CONROE, TX (US); LEE L. RENEAU, CONROE, TX (US)

(73) Assignee: PURE GRAVITY FILTRATION SYSTEMS, LLC, CONROE, TX (US)

(21) Appl. No.: 15/287,803

(22) Filed: Oct. 7, 2016

(51) Int. Cl. B01D 39/16; A47J 37/12

(52) U.S. Cl. CPC B01D 39/1607; B01D 39/1615; B01D 2239/0471; A47J 37/1223; B01D 2239/1291; B01D 39/1623

(57) ABSTRACT

A filter pad is described herein. The filter pad can include carbon and a fibrous material. The filter pad can be used to filter contaminated edible oil. For example, the filter pad can be used to remove total polar molecules and lovibond color red from used cooking oil.

### BACKGROUND

### Field

This invention relates to a filter pad and a method for removing unwanted contaminates from a liquid. In some circumstances, and as described herein, the filter pad can be used to remove impurities from cooking oil. The utilization of cooking oil on a repetitive basis results in an accumulation of Total Polar Molecules (herein, “TPMs”) in the oil. Over a period of time—depending upon several factors, including: the quantity of cooking oil, the moisture content of processed food, and the quantity of food processed therein—the TPMs accumulate until the TPMs produce undesirable characteristics in the food prepared in the oil. These adverse characteristics are usually in the form of the discoloration of the oil, foul odors, excess grease in the food, and an unpalatable taste of the food being fried.

Replacing 100% of the used oil with new oil is neither economically nor environmentally satisfactory. The filter pad disclosed herein provides a means to efficiently remove contaminates and the polar molecules from the oil and restore color so that the oil may be reused many times.

### Description of the Related Art

Systems have been developed for filtering cooking oil and extending the life of the oil for cooking purposes, however each system contains fundamental flaws in method, design and composition. Each of these systems are inadequate in terms of color and overall microfiltration/treatment of the oil. These units lack the ability to restore color and remove contaminants to a level that is appropriate for continued use of the oil.

Accordingly, a need exists for a filter pad that effectively treats the oil and removes contaminants (e.g., TPMs) from the cooking oil and allows the oil to be safely reused without sacrificing the quality of food.

### SUMMARY

From the moment cooking oil is manufactured, it begins to deteriorate due to exposure to environmental components including oxygen, heat, water, and light. When heated, oil starts to form unwanted components such as aldehydes and ketones, dienes, acids, and higher peroxide and anisidine values. Failure to protect cooking oil from these chemical changes or failure to remove these unwanted components can result in the degradation of color and the formation of chemical chains eventually resulting in the cooking oil becoming rancid. Specifically, it is the hydrolysis and/or autoxidation of fats into short-chain aldehydes and ketones that result in the depreciation of color and are objectionable in taste and odor. As a result of such exposure, the cooking oil begins to break down and form Free Fatty Acids and oxidative substances known as aldehydes and ketones. Cooking oil that becomes rancid has a rank, unpleasant smell or taste, and is undesirable for cooking or consumption. The filter pad described herein provides a means for removal of these unwanted impurities in used cooking oil. Removal of these contaminates allows a user to continuously use and filter the cooking oil.

A key benefit of this filter pad is the environmental impact of its use. According to a 1998 study by the National Renewable Energy Laboratory, about 9 pounds of used cooking oil are generated per person per year. According to an article published in 2014 by National Geographic (Eating Water Up: The Water “Footprint” of Food), 25,682 gallons of water per capita per year is required to meet the demand for Soybean Oil. With the current U.S. population of about 325 million people, that converts to just over 8 trillion gallons of water per year required to make this oil for the U.S. alone. This filter pad is capable of allowing the reuse of up to 85% of cooking oil, which translates to the potential to conserve nearly 7 trillion gallons of water, enough to provide enough water for New York City for over 19 years.

In addition to the water conservation benefits this filter pad provides, the filter pad can assist in preventing the coagulation of city sewer systems. The Wall Street Journal reported that at least 75% of the nation's sewage pipelines are operating at less than 50% capacity due to the problems arising from Fats, Oils and Greases being improperly disposed of and into city pipelines. When used as intended, this filter pad is capable of reusing the oil many times, significantly reducing the rate and quantity of oil being discarded.

### BRIEF DESCRIPTION OF THE DRAWINGS

FIG. 1 depicts a side view of a filter pad, according to one or more embodiments described.

### DETAILED DESCRIPTION

A design and method for using a filter pad 100 is provided. The filter pad can include one or more filtration stages for the purpose of removing unwanted contaminates from a liquid. In one or more embodiments and for purposes described herein, the liquid to be filtered by the filter pad can include cooking oil. However, the filter pad described herein can be used to filter a variety of liquids, including but not limited to: alcohol, water, or other forms of oil (e.g., motor oil). The term “cooking oil” can include any type of oil used for cooking. This includes oils typically used for frying foods. For example, cooking oil can include peanut oil, vegetable oil, canola oil, sunflower oil, safflower oil, sesame oil, corn oil, avocado oil, mustard oil, palm oil, rice bran oil, semi-final filtered sesame oil, and semi-final filtered sunflower oil. Cooking oil can also include, but is not limited to: olive oil, palm oil, soybean oil, canola oil (rapeseed oil), and other vegetable oils.

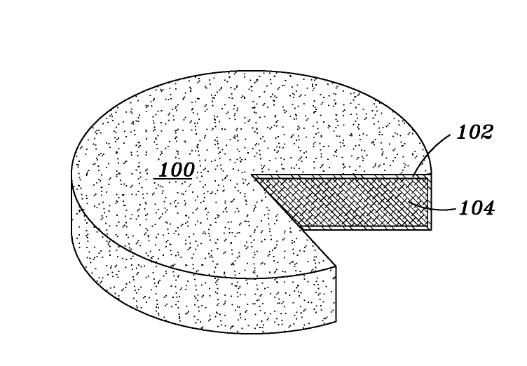

FIG. 1 depicts a side view of a filter pad 100. Though the filter pad 100 is shown here to be a circular disc, the filter pad 100 can be modified in shape and composition to accomplish the filtering needs of the particular application. Many variables can affect the overall success of the filter, and, therefore, the filter can be modified in light of those variables in order to perform to the users desires. For example, the filter pad 100 can be increased in size (e.g., volume capacity). In some circumstances, the liquid being filtered may be of a different viscosity, and may require a different compression density of the filter pad (e.g. the filter pad can be altered in composition and density and be used as a water filter). In one or more embodiments, the filter pad 100 can include 100% FDA compliant material. In one or more embodiments, the filter pad 100 can include a handle, which may serve to make the filter pad 100 more easily handled. The filter pad 100 can also include a flange or extension which may be used to secure the filter pad 100 into a preselected position.

The filter pad can be designed to filter cooking oil so that the filtered oil can be used again and again. Therefore, a benefit of this filter pad is the ability to use the filtered oil many times over. Depending on the type of food being cooked with the cooking oil (e.g., frying chicken tenders, frying vegetables, etc.), the cooking oil can be filtered and reused. As the cooking oil is used to cook food, the food will absorb and remove about 15-20% of the cooking oil in most residential applications. When this happens, a user can replace the absorbed cooking oil with new cooking oil. This can occur with each use, with the user replacing the cooking oil absorbed by the food with new, unused cooking oil. For example, 5 cups of cooking oil can be used to fry chicken tenders. As the chicken cooks, it may absorb 1 cup of cooking oil. The user can filter the remaining 4 cups of cooking oil through the filter pad and add 1 cup of new cooking oil to provide a second batch of cooking oil. The second batch of cooking oil can be used to fry a second batch of chicken tenders. As the second batch of chicken cooks, it may absorb 1 cup of the second batch of cooking oil. The user can filter the remaining 4 cups of the second batch of cooking oil and add 1 cup of new cooking oil to provide a third batch of cooking oil, and so on. With each batch of cooking oil, the food will naturally absorb some of the oil, and that amount of oil can be replaced with new cooking oil. With the effectiveness of the filter pad and replacing the absorbed cooking oil with new oil, the cooking oil can be used significantly longer, as it will remain in good condition for cooking, as defined by its level of contaminates described herein. In many circumstances, recycled or reused cooking oil is preferred to new cooking oil.

In one or more embodiments, the filter pad can be configured to filter a batch of oil in the time frame of 8-24 hours. This slow filtration process can allow the oil to contact the filtration medium for a desired length of time. A benefit of this is that the batch of oil will be filtered and ready for use the next day, which is particularly beneficial if the user intends to fry consecutive days.

The filter pad can be composed of one or more layers, two or more layers, three or more layers, four or more layers, or five or more layers. As shown, the filter pad 100 can include two layers: an inner layer 104 and an outer layer 102. The outer layer 102 can include a filter paper, meshed material, or other material configured to allow oil to flow through the outer layer 102 and the inner layer 104 of the filter pad 100. The outer layer 102 can include a filter paper made, at least partially, of a Rayon-based filter paper. The inner layer 104 can include a filter composite, and can be referred to herein as a “filter composite” or “filter medium”.

In one or more embodiment the outer layer 102 can be composed of a rayon-based filter paper having a weight of about 1.50 ounces per square yard (OSY). The outer layer 102 can have an air permeability of 425 CFM (Frazier number). The outer layer 102 can have a typical value of 5 CD and 20 MD dry tensile strength measured by lbs/3″. The outer layer 102 can be composed of any filter type paper, a screen, meshed material, or other material configured to remove solid particulates from oil while allowing the oil to pass through. In some circumstances, it may be more beneficial for a user to first pass the used cooking oil through a pre-filter capable of removing large particulates (e.g., greater that 50 microns). Such a pre-filter can prevent these particulates from clogging the filter pad.

The filter pad can include a fibrous material and carbon. The filter pad can include carbon, cellulose, polyester, and rayon. For example, the filter pad can include a blend comprising about 7 to about 9 grams of filter paper, about 6 to about 8 grams of rayon, about 3 to about 5 grams of polyester, and about 12 to about 16 grams of carbon. The carbon can include powdered activated carbon (e.g., BG-HHM), which can be a liquid phase powdered activated carbon (PAC). The carbon can include granular carbon and/or activated granular carbon. The filter pad can consist of an outer layer of fibrous material containing an inner layer of PAC or granular carbon. The carbon can also be an acid-activated, wood based product and may be capable of adsorbing high and low molecular weight organic impurities. The carbon can have a minimum Iodine Number of about 700 mg/g, and/or a moister of about 10 weight percent (herein, “wt %”), and/or and ash value of about 6.0 wt %. The carbon can have a value less than 200 US Mesh (0.075 mm) of about 90 wt %. The carbon can have a value less than 325 US Mesh (0.045 mm) of about 60 wt % to about 85 wt %. The filter pad can exclude carbon to form a dense micro-filter for less dense liquid applications such as water.

The rayon can be qualified as “regular tenacity”. The rayon can have a denier per filament (DPF) of about 0.8. The rayon can have a length of about ⅛ inch. The polyester can be qualified as “high tenacity”. The polyester can have a denier per filament (DPF) of around 3. The polyester can have a length of about ⅛″. The polyester can be qualified as “low shrink”.

The filter pad can also include a cellulose composition. The cellulose composition can have a weight of about 7.3 ounces per square yard (oz/sq yd). The cellulose composition can have a thickness of about 40 mills. The cellulose composition can have a Frazier Permeability of about 11.7 cfm/ft². The cellulose composition can have a MD tensile strength of about 26 lbs. The cellulose composition can have a wet burst of about 120″. The cellulose composition can have a micron rating of about 22.

The filter pad can be configured of material, and amount thereof, specifically selected to control the flow rate of the used cooking oil, or other liquid, through the filter pad. The flow rate can directly or indirectly effect the contact time used cooking oil has with the filter medium. Contact time is important, as it allows the filter medium to remove undesirable contaminates from the used cooking oil. In at least one embodiment, the wide range in flow rate can be due to the reliance of gravity as the only pressure. The initial flow rate can be substantially faster than the final flow rate due to pressure and specific weight of the fluid.

The flow rate of used cooking oil through the filter pad can be at the rate (herein, “filter flow rate”) measured in (milliliters per hour) per (square centimeter), which is abbreviated herein as “ml/hr/cm²”. The filter pad can have an initial filter flow rate, which is the filter flow rate of the filter pad the first time it is used (e.g., a brand new filter pad) and a final filter flow rate the last time it is used (e.g., the last time the filter pad is used before needing to be replaced). As the filter pad is used, more of the openings are obstructed, therefore slowing the filter flow rate for each subsequent use.

The initial filter flow rate through the filter pad can be from about 1.00 ml/hr/cm², about 1.10 ml/hr/cm², about 1.25 ml/hr/cm², about 1.35 ml/hr/cm², or about 1.40 ml/hr/cm² to about 1.45 ml/hr/cm², about 1.50 ml/hr/cm², about 1.55 ml/hr/cm², about 1.70 ml/hr/cm², or about 1.85 ml/hr/cm². In one or more embodiments, the initial flow rate of through the filter pad can be about 1.5 ml/hr/cm², about 2.5 ml/hr/cm², about 3.5 ml/hr/cm², or about 4.5 ml/hr/cm², to about 5.5 ml/hr/cm², about 6.5 ml/hr/cm², about 7.5 ml/hr/cm², about 8.5 ml/hr/cm², about 9.5 ml/hr/cm², or about 10.5 ml/hr/cm².

The final filter flow rate through the filter pad can be from about 0.25 ml/hr/cm², about 0.35 ml/hr/cm², about 0.45 ml/hr/cm², or about 0.55 ml/hr/cm² to about 0.65 ml/hr/cm², about 0.70 ml/hr/cm², about 0.75 ml/hr/cm², about 0.85 ml/hr/cm², or about 0.10 ml/hr/cm². In one or more embodiments, the final flow rate of through the filter pad can be about 0.5 ml/hr/cm², about 1.5 ml/hr/cm², about 2.5 ml/hr/cm², about 3.5 ml/hr/cm², or about 4.5 ml/hr/cm², to about 5.5 ml/hr/cm², about 6.5 ml/hr/cm², about 7.5 ml/hr/cm², about 8.5 ml/hr/cm², or about 9.5 ml/hr/cm².

The average filter flow rate through the filter pad can be about 0.65 ml/hr/cm², about 0.75 ml/hr/cm², about 0.85 ml/hr/cm², about 0.95 ml/hr/cm² to about 1.05 ml/hr/cm², about 1.15 ml/hr/cm², about 1.25 ml/hr/cm², about 1.35 ml/hr/cm², about 1.45 ml/hr/cm², or about 1.55 ml/hr/cm². In one or more embodiments, the initial flow rate of through the filter pad can be about 0.05 ml/hr/cm², about 0.5 ml/hr/cm², about 2 ml/hr/cm², about 3 ml/hr/cm², or about 4 ml/hr/cm², to about 5 ml/hr/cm², about 6 ml/hr/cm², about 7 ml/hr/cm², about 8 ml/hr/cm², about 9 ml/hr/cm², about 10 ml/hr/cm², or about 11 ml/hr/cm².

The filter pad can be configured to have a variety of shapes and sizes, which can each be modified to accomplish a desirable flow rate. In one or more embodiments, the thickness of the filter pad can be selected to accomplish desired filtration. For example, the filter pad can have a thickness of about 0.125 inches to about 2.0 inches, about 0.15 inches to about 1.5 inches, or about 0.3 inches to about 1.3 inches. The filter pad can have a thickness of about 0.125 inches, about 0.25 inches, about 0.5 inches, about 0.75 inches, about 1.0 inch, about 1.25 inches, about 1.50 inches, about 1.75 inches, about 2.0 inches, about 2.5 inches, about 3.0 inches, about 3.0 inches, about 3.5 inches, about 4.0 inches, about 4.5 inches, or about 5 inches. In some embodiments, the filter pad can be greater than 5.0 inches thick.

In one or more embodiments, the filter pad can be generally circular in shape and have a diameter between 1.0 inch and 2.0 feet. For example, the filter pad can have a diameter of about 1.0 inch, about 1.5 inches, about 1.75 inches, about 2.0 inches, about 2.5 inches, about 3.5 inches, about 4.0 inches, about 4.5 inches, or about 5.0 inches. For example, the filter pad can have a diameter of about 6.0 inches, about 7.0 inches, about 8.0 inches, about 9.0 inches, about 10 inches, about 12 inches, about 15 inches, about 18 inches, or about 24 inches. In one or more embodiments, the filter pad can have a diameter of greater than 24 inches.

The filter medium can include carbon (e.g., Calgon BGHHM grade), fibrous material, polyester, rayon, or any combination thereof. Fibrous materials can include any material derived or made from plants. Fibrous materials can include textiles, non-wovens, composite materials, or any combination thereof. Fibrous material can include, but is not limited to, Aramid Fiber, Chipboard, Corrugated board, Felt, Fiberglass, Graphite, Kevlar, Masonite, or Cellulose.

The filter medium can include (by weight percent, “wt %”) about 1.0 wt % fibrous material, about 5.0 wt % fibrous material, about 10 wt % fibrous material, about 15 wt % fibrous material, about 20 wt % fibrous material, about 25 wt % fibrous material, about 30 wt % fibrous material, about 35 wt % fibrous material, about 40 wt % fibrous material, about 45 wt % fibrous material, about 50 wt % fibrous material, about 55 wt % fibrous material, about 60 wt % fibrous material, about 65% wt % fibrous material, about 70 wt % fibrous material, about 75 wt % fibrous material, about 80 wt % fibrous material, about 85 wt % fibrous material, 90 wt % fibrous material, about 95 wt % fibrous material, or about 99 wt % fibrous material. In one or more embodiments, the filter medium can include about 1.0 wt % carbon, about 5.0 wt % carbon, about 10 wt % carbon, about 15 wt % carbon, about 20 wt % carbon, about 25 wt % carbon, about 30 wt % carbon, about 35 wt % carbon, about 40 wt % carbon, about 45 wt % carbon, about 50 wt % carbon, about 55 wt % carbon, about 60 wt % carbon, about 65 wt % carbon, about 65 wt % carbon, about 70 wt % carbon, about 75 wt % carbon, about 80 wt % carbon, about 85 wt % carbon, about 90 wt % carbon, about 95 wt % carbon, or about 99 wt % carbon.

In one or more embodiments, the filter medium can include about 1.0 wt % polyester, about 5.0 wt % polyester, about 20 wt % polyester, about 30 wt % polyester, about 40 wt % polyester, or about 50 wt % polyester. In one or more embodiments, the filter medium can include about 5.0 wt % rayon, about 20 wt % rayon, about 30 wt % rayon, about 40 wt % rayon, about 50 wt % rayon, about 60 wt % rayon, or about 70 wt % rayon.

The filter pad can reduce the amount of undesirable components found in used cooking oil. These undesirable components can include (1) moisture, insoluble impurities, and unsaponifiable matter (collectively, “MIU”); (2) total polar molecules (“TPM”); (3) free fatty acids (“FFA”); (4) peroxide value (“PV”); and (5) anisidine value (“AV”). The used oil can be filtered through the filter pad to provide a filtered oil having significantly reduced concentration of these undesirable components. For example, the filter pad can remove more that 50% of the total TPMs from the used oil.

The filter pad can remove MIUs from the used oil. For example, the filter pad can remove from about 25%, about 35%, about 45%, or about 55% to about 65%, about 75%, about 85%, or about 95% of the MIUs from the used oil. The filtered oil can have an MIU concentration of about 0.25 wt %, about 0.50 wt %, about 0.75 wt %, or about 1 wt % to about 1.5 wt %, about 1.25 wt %, about 1.5 wt %, about 2.0 wt %, about 2.5 wt %, about 3.0 wt %, or about 3.5 wt %.

The filter pad can remove FFAs from the used oil. For example, the filter pad can remove from about 0.05%, about 1.0%, about 10%, about 15%, about 25%, or about 35% to about 45%, about 55%, about 65%, or about 75% of the FFAs from the used oil. The filtered oil can have an FFA concentration of about 0.05 wt %, about 0.10 wt %, about 0.20 wt %, about 0.30 wt %, or about 0.50 wt % to about 0.75 wt %, about 1 wt %, about 1.5 wt %, about 2.0 wt %, about 2.5 wt %, about 3.0 wt %, about 4.0 wt %, or about 5.0 wt %.

The filter pad can reduce the PV value of the used oil. For example, the filter pad can reduce the PV value by about 20%, about 30%, about 40%, about 50%, about 55%, about 60%, about 65%, about 70%, about 80%, or about 90%. The filtered oil can have a PV value of about 1.0 milliequivalents (1 milliequvaluent=peroxide oxygen per 1 kilogram of fat or oil, commonly known in the industry), about 3.0 milliequivalents, about 5.0 milliequivalents, about 6.0 milliequivalents, about 7.0 milliequivalents, about 8.0 milliequivalents, or about 9.0 milliequivalents to about 10 milliequivalents, about 12 milliequivalents, about 14 milliequivalents, about 16 milliequivalents, about 18 milliequivalents, about 20 milliequivalents, about 22 milliequivalents, about 24 milliequivalents, about 26 milliequivalents, or about 28 milliequivalents.

The filter pad can reduce the AV value of the used oil. For example, the filter pad can reduce the AV value by about 5%, about 10%, about 15%, about 18%, about 25%, about 35%, about 45%, or about 50%. The filtered oil can have an AV value of 2.0, about 10.0, about 15.0, about 20.0, or about 25.0 to about 30.0, or about 35.0.

In one or more embodiments, the filter pad can remove more that 10% of the TPMs from the used oil. In one or more embodiments, the filter pad can remove more than 20% of the TPMs from the used oil. In one or more embodiments, the filter pad can remove more that 30% of the TPMs from the used oil. In one or more embodiments, the filter pad can remove more that 40% of the TPMs from the used oil. In one or more embodiments, the filter pad can remove more than 50% of the TPMs from the used oil. In one or more embodiments, the filter pad can remove more than 60% of the TPMs from the used oil. In one or more embodiments, the filter pad can remove more than 70% of the TPMs from the used oil. The filtered oil can have a TPM concentration of about 5.0 wt % (weight percent), about 7.5 wt %, about 10 wt %, about 15 wt %, or about 20 wt %. The filtered oil can have a TPM concentration of about 4.0 wt % (weight percent), about 8.0 wt %, or about 11.0 wt % to about 16.0 wt %, about 18.0 wt %, or about 21 wt %.

The filter pad can also remove the amount of Lovibond color red from the used oil. For example, the filter pad can remove more than 25% of the Lovibond color red from the used oil. In one or more embodiments, the filter pad can remove more than 40% of the Lovibond color red from the used oil. In one or more embodiments, the filter pad can remove more than 50% of the Lovibond color red from the used oil. In one or more embodiments, the filter pad can remove more than 70% of the Lovibond color red from the used oil. In one or more embodiments, the filter pad can remove more than 90% of the Lovibond color red. The filtered oil can have a Lovibond color red value of about 0.05, about 0.5, about 1.0, about 2.0, or about 2.5 to about 4.0, about 5.0, about 6.0, about 7.5, or about 10.

### Test

The filter pad described herein was incorporated into a filtration system (referred to below as “Pure Gravity filtration system”) and was tested against an existing product produced by Tasuka Corporation (herein referred to as the “Tasuka filtration system”).

Over the course of two days, twenty-eight and a half pounds (28.5 lbs.) of battered meat and vegetables were deep fried in oil at, or about, 350 degrees Fahrenheit (° F.). The used oil was then filtered through a pre-filter (Rockline Industries coffee filter—rated at about 100 microns) to remove heavy solids to provide a particulate filtered used oil. Then, a sample of the particulate-lean used oil was filtered through the Pure Gravity filtration system, and a second sample of the particulate-lean used oil was filtered through the Tasuka filtration system. A third sample of the particulate-lean used oil was used as the control. A sample was taken from each of these filtered oils and the following characteristics were measured: (1) Lovibond—color: red, yellow (as shown in Table 2); (2) moisture, insoluble impurities, and unsaponifiable matter (collectively, “MIU”); (3) total polar molecules (“TPM”); (4) free fatty acids (“FFA”); peroxide value (“PV”); and (5) anisidine value (“AV”) (as shown in Table 1). The color was measured according to the Lovibond standard using American Oil Chemist Society's (“AOCS”) method Cc 13b-45. The MIU value was measured according to AOCS methods Ca 2d-25, Ca 3a-46, Ca 6a-40, and Cd 12b-92. TPM content was measured by column chromatography using the AOCS method Cd 20-91. The FFA content was measured using AOCS method 5a-40. The PV was measured using AOCS method Cd 8-53. The AV was measured using an automated Foodlab Touch instrument.

TABLE 1

| | TPM | FFA | PV | | MIU |
|---|---|---|---|---|---|
| | (wt %) | (wt %) | (milliequivalents) | AV | (wt %) |
| Used oil (control) | 21.50 | 0.36 | 14.0 | 18.96 | 0.53 |
| Tasuka | 11.20 | 0.32 | 6.2 | 19.85 | 0.56 |
| Pure Gravity | 9.62 | 0.28 | 4.8 | 15.90 | 0.50 |
| New, unfiltered | 1.50 | 0.05 | 0.6 | 0.85 | |
| oil | | | | | |

TABLE 2

| | Lovibond - Yellow | Lovibod - Red |
|---|---|---|
| Used oil | 70 - yellow | 7.0 - red |
| Tasuka | 38 - yellow | 4.7 - red |
| Pure Gravity | 11 - yellow | 1.7 - red |

As shown in Table 1, the Pure Gravity Filter provided a filtered used oil having less TPMs, less FFAs, lower PV value, and lower AV value than the Tasuka filter system and the particulate-lean control. As shown, the Tasuka filtration system reduced the TPM concentration from 21.50 to 11.20. The Pure Gravity filtration system, however, reduced the TPM concentration from 21.50 to 9.62.

As shown in Table 2, the filtration of the used cooking oil through the Pure Gravity filtration system improves Lovibond color results exceedingly compared to the Tasuka filtration system. As shown in Table 2, the Tasuka filtration system reduced the Lovibond color yellow from 70-yellow to 38-yellow. However, the Pure Gravity filtration system reduced the Lovibond color yellow from 70-yellow to 11-yellow. Similarly, the Pure Gravity filtration system removed far more Lovibond color red from the used oil that the Tasuka filtration system. As shown in Table 2, the Tasuka filtration system reduced the Lovibond color red from 7.0-red to 4.7-red, and the Pure Gravity filtration system reduced the Lovibond color red from 7.0-red to 1.7-red.

The most notable difference between the Pure Gravity filter system and the Tasuka filter system is the color. For most households and commercial businesses, color is the determining factor of when to discard used cooking oil. It is also believed to be the most critical factor in taste and color of the food being fried. The Pure Gravity filter system removed more than double the Lovibond color “red”, a 76% removal compared to the 36% removal demonstrated by the Tasuka filter system. See Table 2.

Independent of the comparison the Tasuka filter system and the coffee filters, the Pure Gravity filter system restored the used oil to its “sweet spot” (typically in the range of 9 to 12 TPM), making the oil more desirable for repeated use.

Certain embodiments and features have been described using a set of numerical upper limits and a set of numerical lower limits. It should be appreciated that ranges including the combination of any two values, e.g., the combination of any lower value with any upper value, the combination of any two lower values, and/or the combination of any two upper values are contemplated unless otherwise indicated. Certain lower limits, upper limits and ranges appear in one or more claims below. All numerical values are “about” or “approximately” the indicated value, and take into account experimental error and variations that would be expected by a person having ordinary skill in the art.

Various terms have been defined above. To the extent a term used in a claim is not defined above, it should be given the broadest definition persons in the pertinent art have given that term as reflected in at least one printed publication or issued patent. Furthermore, all patents, test procedures, and other documents cited in this application are fully incorporated by reference to the extent such disclosure is not inconsistent with this application and for all jurisdictions in which such incorporation is permitted.

While the foregoing is directed to embodiments of the present filter pad, other and further embodiments of the filter pad may be devised without departing from the basic scope thereof, and the scope thereof is determined by the claims that follow.

What is claimed is:

1. A filter pad, comprising carbon.

2. The filter pad of claim 1, further comprising a fibrous material.

3. The filter pad of claim 2, wherein the filter pad can filter used cooking oil to produce a filtered oil.

4. The filter pad of claim 1, wherein the filter pad has an average filter flow rate of 0.5 ml/hr/cm² to about 10 ml/hr/cm².

5. The filter pad of claim 3, wherein the filter pad is configured to remove more than 50% of the total polar molecules from the used cooking oil.

6. The filter pad of claim 3, wherein the filter pad is configured to remove more than 40% of the Lovibond color red from the used cooking oil.

7. A filter pad, comprising:
a filter medium comprising at least 1.0 wt % fibrous material and at least 1.0 wt % carbon.

8. The filter pad of claim 7, wherein the fibrous material is natural or synthetic fibrous material.

9. The filter pad of claim 7, wherein the filter pad comprises up to 99 wt % fibrous material.

10. The filter pad of claim 7, wherein a used cooking oil is passed through the filter pad to produce a filtered oil.

11. The filter pad of claim 10, wherein the filter pad can remove more than 50% total polar molecules from used cooking oil.

12. The filter pad of claim 10, wherein the filter pad can remove more than 40% of the Lovibond color red from used edible oil.

13. The filter pad of claim 7, wherein the at least 1.0 wt % fibrous material is encapsulated in cellulose and configured to prevent carbon migration.

14. The filter pad of claim 10, wherein the filtered oil comprises a total polar molecule concentration of about 4.0 wt % to about 14 wt %.

15. The filter pad of claim 10, wherein the filtered oil comprises a free fatty acid concentration of about 0.05 wt % to about 4.0 wt %.

16. The filter pad of claim 10, wherein the filtered oil comprises a peroxide value of about 1.0 milliequivalents to about 6.0 milliequivalents.

17. The filter pad of claim 10, wherein the filtered oil has a Lovibond color red value of about 0.5 to about 4.0.
